(19) United States
(12) Patent Application Publication
(10) Pub. No.: US 2026/0319510 A1
(43) Pub. Date: Oct. 15, 2026

(54) ROBOT TRAVELING TOGETHER WITH EXTERNAL ROBOT AND TRAVEL METHOD THEREOF

(71) Applicant: SAMSUNG ELECTRONICS CO., LTD., Suwon-si (KR)

(72) Inventors: Kihoon KIM, Suwon-si (KR); Boseok MOON, Suwon-si (KR); Muwoong LEE, Suwon-si (KR); Koeun CHOI, Suwon-si (KR)

(73) Assignee: SAMSUNG ELECTRONICS CO., LTD., Suwon-si (KR)

(21) Appl. No.: 19/697,173

(22) Filed: Jun. 3, 2026

Related U.S. Application Data
(63) Continuation of application No. PCT/KR2024/019384, filed on Nov. 29, 2024.

(30) Foreign Application Priority Data
Dec. 19, 2023 (KR) 10-2023-0186347

(51) Int. Cl. G05D 1/639; G05D 1/244; G05D 1/246; G05D 1/65; G05D 1/678; G05D 1/698; G05D 109/10; G05D 111/10; G05D 111/50; G06T 7/73

(52) U.S. Cl. CPC G05D 1/639; G05D 1/244; G05D 1/246; G05D 1/65; G05D 1/678; G05D 1/6985; G06T 7/73; G05D 2109/10; G05D 2111/10; G05D 2111/58; G06T 2207/30204

(57) ABSTRACT

A robot, a computer-readable recording medium and a method of controlling the robot are provided. The robot includes a driver, memory for storing at least one instruction, characteristic information of the robot and map data, an interface; and at least one processor. The at least one processor when executing the at least one instruction causes the robot to, based on obtaining, through the interface, characteristic information of at least one external robot that is to travel by following the robot, store the characteristic information of the at least one external robot in the memory, based on at least one of the characteristic information of the robot, the map data, and the characteristic information of the at least one external robot, set a path through which the robot and the at least one external robot can sequentially pass within the space, and control the driver to travel along the path.

### CROSS-REFERENCE TO RELATED APPLICATIONS

This application is a Continuation Application of International Application No. PCT/KR2024/019384 filed on Nov. 29, 2024, which claims priority to Korean Patent Application No. 10-2023-0186347, filed on Dec. 19, 2023, at the Korean Ministry of Intellectual Property, the disclosures of which are incorporated herein in their entireties by reference.

### BACKGROUND

### 1. Field

The disclosure relates to a robot that can travel together with external robots, and a travel method thereof.

### 2. Description of Related Art

Fueled by development of robot technologies, various robots such as a robot cleaner, a mobile projector, a serving robot, etc. are being developed and distributed. In particular, cases wherein robots are being utilized for transporting heavy objects in places such as a hotel, an airport, a factory, etc. are increasing more and more.

In this regard, there was a case wherein a plurality of robots loaded a large amount of objects by sharing them, and travelled along the same path for transporting a large amount of objects to a destination. In this case, control was performed such that other robots followed the path on which a robot in the lead of the group was travelling, and a large amount of objects could thereby be transported at once. However, as the robot in the lead of the group set a travel path without considering characteristic information of the other robots belonging to the group such as the sizes, the speed, the turning radiuses, etc. of the robots, and the other robots just followed the travel path of the robot in the lead, various problems such as there being a possibility that the other robots belonging to the group could collide with a wall or an obstacle existing in the travel space, etc. occurred.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

According to at least one aspect of the disclosure, a robot may include a driver, memory for storing at least one instruction, characteristic information of the robot, and map data, an interface, and at least one processor, wherein the at least one processor when executing the at least one instruction may cause the robot to, based on obtaining, through the interface, characteristic information of at least one external robot configured to travel by following the robot, store the characteristic information of the at least one external robot in the memory, and based on at least one of the characteristic information of the robot, the map data, and the characteristic information of the at least one external robot, set a path through which the robot and the at least one external robot can sequentially pass within the space, and control the driver to travel along the path.

According to at least one aspect of the disclosure, a travel method of a robot may include the steps of based on obtaining characteristic information of at least one external robot configured to travel by following the robot, setting a path through which the robot and the at least one external robot can sequentially pass within a space based on characteristic information of the robot and the characteristic information of the at least one external robot; and controlling the robot to travel based on the path.

According to at least one aspect of the disclosure, in a computer-readable recording medium including a program for executing a travel method of a robot, the travel method may include the steps of, based on obtaining characteristic information of at least one external robot that is to travel by following the robot, setting a path through which the robot and the at least one external robot can sequentially pass within a space based on characteristic information of the robot and the characteristic information of the at least one external robot; and controlling the robot to travel based on the path.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for illustrating a robot according to at least one embodiment of the disclosure;

FIG. 2 is a block diagram for illustrating a configuration of a robot according to at least one embodiment of the disclosure;

FIG. 3 is a diagram for illustrating a method of setting a travel path of a robot according to at least one embodiment of the disclosure;

FIG. 4 is a diagram for illustrating a method of setting a travel path of a robot according to at least one embodiment of the disclosure;

FIG. 5 is a diagram for illustrating a method of physically connecting a robot according to at least one embodiment of the disclosure;

FIG. 6 is a diagram for illustrating a method of determining a virtual shape of a robot according to at least one embodiment of the disclosure;

FIG. 7 is a diagram for illustrating a method of connecting a robot and an external robot according to at least one embodiment of the disclosure;

FIG. 8 is a diagram for illustrating a method of resetting a travel path of a robot according to at least one embodiment of the disclosure;

FIG. 9 is a diagram for illustrating a method of setting a travel path of a robot that is physically connected according to at least one embodiment of the disclosure; and

FIG. 10 is a diagram for illustrating a method of setting a travel path of a robot including a marker according to at least one embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. In addition, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, the terms used in the disclosure are used only to explain specific embodiments, and are not intended to limit the scope of the disclosure. Also, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, the embodiments according to the disclosure will be described in detail with reference to the accompanying drawings, such that those having ordinary skill in the art to which the disclosure belongs can easily carry out the disclosure.

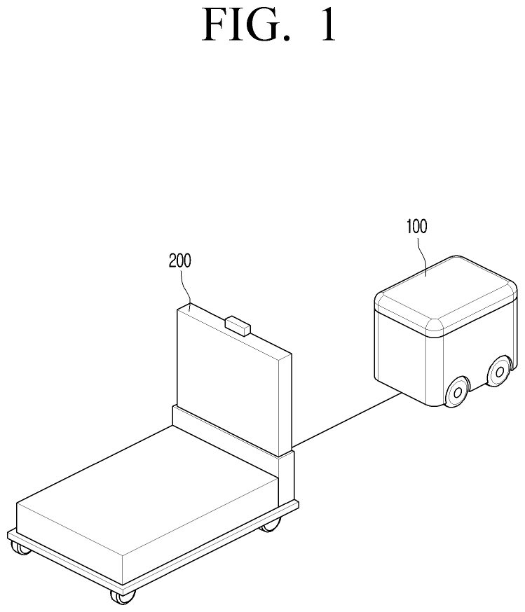

FIG. 1 is a diagram for illustrating a robot according to at least one embodiment of the disclosure.

A robot may be a device that can travel while it is not directly controlled by a person. According to FIG. 1, a robot 100 may be connected to an external robot 200 that moves while loading an object that needs to be carried, and the robot 100 may set a path such that it can travel together with the external robot 200 to a destination. The robot 100 may be referred to as various terms such as an autonomous driving device, an autonomous mobile robot (AMR), an automated guided vehicle (AGV), an unmanned ground vehicle (UGV), etc., but it will be described as the robot 100 in the disclosure. The robot 100 may be implemented as various types of robots, etc. that perform necessary tasks while travelling in a space such as a cleaning robot, a serving robot, a mobile projector, an industrial robot, a guide robot, a delivery robot, etc. according to the method of using or the use.

FIG. 1 illustrates a case wherein the plurality of robots 100, 200 are linked. Each robot 100, 200 may be implemented in the same size or shape, or type, or may be implemented in different sizes or shapes, or types. For the convenience of explanation, in the disclosure, based on one robot 100, other robots will be referred to as the external robot 200.

The external robot 200 may be implemented as a transport robot that moves while loading an object that needs to be carried as illustrated in FIG. 1, but it may also be implemented as various types of robots, etc. that perform necessary tasks while travelling in a space such as a cleaning robot, a serving robot, a mobile projector, a guide robot, a delivery robot, etc.

In FIG. 1, a robot that travels in the lead between the plurality of robots 100, 200 that are connected with each other and sequentially travel may be referred to as a leader robot, and the robot that follows it may be referred to as a sub robot. In FIG. 1, a case wherein the robot 100 performs the role of a leader robot was illustrated, but the disclosure is not necessarily limited thereto, and at least some of the contents that will be explained below may be applied to a case wherein the robot 100 performs the role of a sub robot.

Here, the feature that “the robot 100 is connected with the external robot 200” may mean that the robot 100 and the external robot 200 form one group that travels on the same path toward the same destination. For example, the robot 100 may be connected with the external robot 200 by a physical tool. In case the robot 100 and the external robot 200 are physically connected, the external robot 200 cannot help moving together following the travelling of the robot 100, and thus they may form one group that travels on the same path toward the same destination.

As still another example, the robot 100 and the external robot 200 may be connected with each other through a communication session without being physically connected, and the external robot 200 may be implemented to follow the robot 100 by recognizing the shape or a specific part, or a marker, etc. of the robot 100. In this case, the robot 100 and the external robot 200 may be logically connected, and thus may form one group that travels on the same path toward the same destination.

Specifically, in case a sensor provided on the external robot 200 was implemented to sense a marker provided on the exterior of the robot 100, the external robot 200 may follow the robot 100 based on a sensing result of the marker. In other words, even without physical connection, the robot 100 and the external robot 200 may operate as one group as if they were physically connected with each other. As described above, in the disclosure, a case wherein the robot 100 and the external robot 200 operate as one group as above will be described as “being connected.”

In this case, as the robot 100 travels, the external robot 200 cannot help moving together following the travelling of the robot 100 for sensing the marker provided on the exterior of the robot 100, and by this, the robot 100 and the external robot 200 may form one group that travels on the same path toward the same destination. Also, connection between the robot 100 and the external robot 200 may be formed by various methods without being limited to the aforementioned method, such as connection between the robot 100 and the external robot 200 being formed by measuring the distance from the robot 100 through various types of sensors that can measure distance such as a LiDAR sensor, a ToF sensor, etc. provided on the external robot 200 and controlling such that the distance between the external robot 200 and the robot 100 can be maintained to be constant.

After the robot 100 according to the disclosure is connected with the external robot 200, the robot 100 may set a path by reflecting both of the characteristic information of the robot 100 and the characteristic information of the external robot 200.

Here, “the characteristic information” may include “appearance characteristic information” and “travel characteristic information.” The appearance characteristic information may include various types of information that constitute the appearance of the robot such as the shape and the size of the robot, whether a marker exists, etc. Also, the travel characteristic information may include various types of information that reflect travel characteristics of the robot such as the maximum travel speed, the turning radius, the driving method, etc. of the robot.

The robot 100 according to the disclosure sets a path by reflecting both of the characteristic information of the robot 100 and the characteristic information of the external robot 200, and thus the robot 100 and the external robot 200 can travel to a destination without colliding with a wall and an obstacle existing in a space, and this will be described in more detail from below.

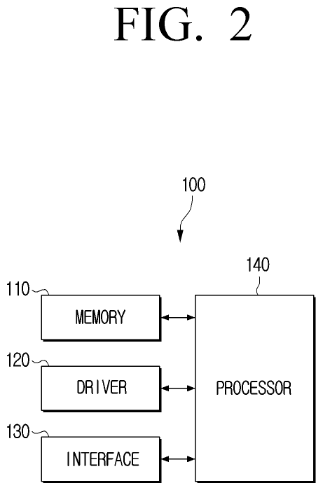

FIG. 2 is a block diagram for illustrating a configuration of a robot according to at least one embodiment of the disclosure.

According to FIG. 2, the robot 100 may include memory 110, a driver 120, an interface 130, and a processor 140.

The memory 110 may store the characteristic information of the robot 100 and map data for a travel space. Also, the memory 110 may store at least one instruction regarding the robot 100, an operating system (O/S) for driving the robot 100 or other software modules, applications, data, etc. In addition, the memory 110 may include volatile memory such as a frame buffer, semiconductor memory such as flash memory, etc., or a magnetic storage medium such as a hard disk, etc.

The processor 140 may control the operations of the robot 100 by executing the various types of software modules stored in the memory 110. Meanwhile, in the disclosure, the term memory 110 may be used as a meaning including the memory 110, ROM (not shown) and RAM (not shown) inside the processor 140, or a memory card (not shown) (e.g., a micro SD card, a memory stick) installed in the robot 100.

The driver 120 is a component that may move the robot 100. The driver 120 may include components such as a plurality of wheels, a driving motor for rotating each of the plurality of wheels, a gear, a shaft, etc. The plurality of wheels are provided on the lower side or a side surface of the main body of the robot 100, and support the main body of the robot 100 from the bottom surface. When the driving motor operates, and the driving force is transmitted to the plurality of wheels and each wheel gets to rotate, the robot 100 may be moved by a frictional force between the bottom surface and the wheels. Other than the above, when changing the direction, the driver 120 may vary the rotation speed of at least one wheel among the plurality of wheels, or adjust an alignment direction of the wheel differently. According to the type of the robot 100 or the weight of a loaded product, and the use environment of the robot 100, a continuous track, etc. may be used instead of wheels.

The interface 130 may include at least one of a communication interface, a manipulation interface, or an input/output interface. For example, the communication interface is a component for performing communication with at least one external robot 200. The communication interface may include at least one wireless communication module, at least one wired communication module, etc. Each communication module may be implemented in a form of at least one hardware chip. A wireless communication module may include at least one module among a Wi-Fi module, a Bluetooth module, an infrared communication module, or other communication modules. Other than the above, the communication interface may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. A wired communication module may include, for example, at least one of a local area network (LAN) module, an Ethernet module, a pair cable, a coaxial cable, an optical fiber cable, or an ultra wide-band (UWB) module. Other than the above, the communication interface may further include an IR reception module for receiving IR signals of various types of external devices.

The communication interface may be implemented in various forms as above, and perform communication with the external robot 200, and may thereby receive various types of data such as the characteristic information of the external robot 200 or sensing data of the external robot 200, etc. from the external robot 200.

The manipulation interface is a component for receiving input of a user manipulation. The manipulation interface may include various types of buttons, a touch screen, etc. provided on the robot 100.

The input/output interface is a component for inputting or outputting various types of external signals. The input/output interface may be connected with various types of external memories or external devices (e.g., a web server, a user terminal device, etc.), and receive input of various types of data. At least a part of the input/output interface may be connected with the communication interface. For example, the input/output interface may transmit information received from an external device to the communication interface, or transmit information received through the communication interface to the external device.

The processor 140 may be connected with the memory 110, the driver 120, and the interface 130, and control overall operations and functions of the robot 100.

The processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. In FIG. 2, one processor 140 was illustrated, but the number of the processor 140 may be implemented diversely. The at least one processor 140 may control one or a random combination of other components of the robot 100, and perform an operation related to communication or data processing. The at least one processor 140 may perform the method according to the various embodiments of the disclosure by executing the one or more programs or instructions stored in the memory 110.

Meanwhile, in case the method according to an embodiment of the disclosure includes a plurality of operations, the plurality of operations may be performed by one processor, or performed by a plurality of processors.

Also, the at least one processor 140 may be implemented as a single core processor including one core, or it may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor 140 may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

The processor 140 may obtain characteristic information of at least one external robot 200 that will travel by following the robot 100 through the interface 130.

Here, the feature of “travelling by following the robot 100” may mean travelling on the same path toward the same destination as the robot 100. For example, in case the robot 100 and the external robot 200 are connected through a physical tool, the external robot 200 cannot help travelling on the same path as the robot 100 according to the physical connection, and thus the external robot 200 may travel by following the robot 100.

According to an embodiment, in case the interface 130 includes a communication interface, the processor 140 may receive the characteristic information of the external robot 200 from the external robot 200 through the communication interface.

According to another embodiment, in case the interface 130 includes a manipulation interface, the processor 140 may receive input of the characteristic information of the external robot 200 from the user through the manipulation interface. In other words, the user may directly input information that the horizontal length of the external robot 200 is 80 cm, and the maximum travel speed is 4 m/s through a button or a touch screen, etc. provided on the robot 100, and the robot 100 may obtain the characteristic information of the external robot 200 by receiving the user's input.

Also, in case the interface 130 includes an input/output interface, the processor 140 may obtain the characteristic information of the external robot 200 through the interface 130 based on various methods, such as the processor 140 receiving input of the characteristic information of the external robot 200 from an external server device or a user terminal device through the input/output interface.

The processor 140 may store the obtained characteristic information of the external robot 200 in the memory 110.

As described above, the characteristic information of the external robot 200 may include appearance characteristic information and travel characteristic information of the external robot 200. For example, if the external robot 200 is a robot in a cuboid shape, the appearance characteristic information of the external robot 200 may include length information regarding the width, the length, and the height of the cuboid, and the travel characteristic information of the external robot 200 may include information regarding the turning radius and the maximum travel speed of the external robot 200.

According to an embodiment, the processor 140 may store the information that the external robot 200 is a robot in a cuboid shape, and the horizontal length is 50 cm, the vertical length is 80 cm, and the height is 2 m in the memory 110. According to another embodiment, the processor 140 may store the information that the maximum travel speed of the external robot 200 is 4 m/s, and the turning radius is 1 m in the memory 110.

In the aforementioned explanation, only information regarding the shape, the size or the turning radius, and the travel speed of the external robot 200 was explicitly described, but it is obvious that various types of information related to appearance and travelling such as the type, the weight, and the size of an object loaded by the robot 100, the weight of the external robot 200, the driving method of the external robot 200, and the type, the weight, and the size of an object loaded by the external robot 200, etc. can be stored in the memory 110. In case information related to an object loaded by the external robot 200 is owned by the external robot 200, the information can be received through the communication interface like the aforementioned other information. However, in case information related to a loaded object is not owned by the external robot 200, or is difficult to be identified in the external robot 200, the robot 100 may receive input of information regarding characteristics of a loaded object through the input/output interface or the manipulation interface. For example, in case an object having a wider width than the width of the external robot 200 is loaded on the external robot 200, the user may input information regarding the width of the object into the robot 100.

The processor 140 may set a travel path through which the robot 100 and the external robot 200 can sequentially pass within a space based on the information stored in the memory 110.

Here, the information stored in the memory 110 may include the characteristic information of the robot 100, the characteristic information of the external robot 200, and map data for a travel space. Also, various types of information regarding the travelling of the robot 100 (e.g., the target travel time, a stopover) obtained by the processor 140 through the interface 130 may be stored in the memory 110.

Here, “a travel path through which the robot 100 and the external robot 200 can sequentially pass” may mean a travel path through which the robot 100 and the external robot 200 can arrive at a destination in order without a risk that luggage loaded on the robot 100 and the external robot 200 may fall or the luggage may be damaged, and may include a travel path through which the robot 100 and the external robot 200 can arrive at a destination in order without colliding with a wall or other obstacles existing in the travel space. Alternatively, in case the weight of an object loaded on the robot 100 or the external robot 200 is very heavy, an area wherein damage to the bottom is not generated in a transport process may be included in a travel path. Alternatively, in case an object loaded on the robot 100 or the external robot 200 is a product that can be easily damaged by external shock (e.g., a glass product, etc.), the processor 140 may set a travel path as an area wherein there is no moving object or there are few of such objects.

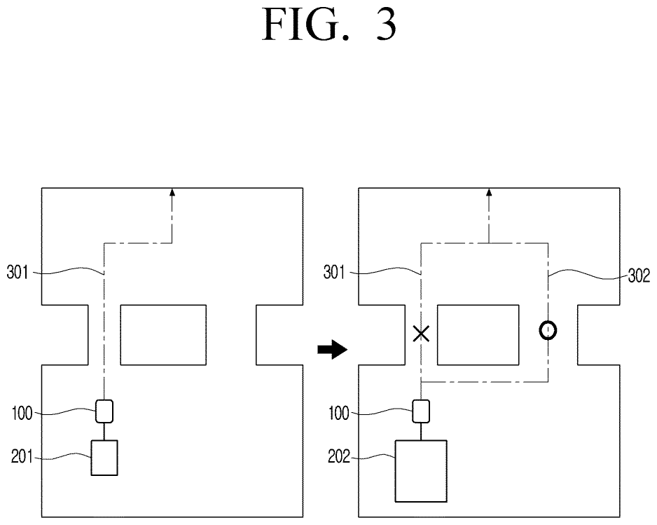

According to an embodiment, the processor 140 may set a travel path through which the robot 100 and the external robot 200 can sequentially pass by using the appearance characteristic information of the robot 100 and the appearance characteristic information of the external robot 200. The method for the processor 140 to set a travel path through which the robot 100 and the external robot 200 can sequentially pass will be described in detail in the explanation regarding FIG. 3 that will be described below.

FIG. 3 is a diagram for illustrating a method of setting a travel path of a robot according to at least one embodiment of the disclosure.

According to FIG. 3, the processor 140 may set a travel path based on appearance characteristic information of a first external robot 201 or a second external robot 202 connected to the robot 100.

For example, as illustrated in FIG. 3, the processor 140 may set a first travel path 301 on which a robot passes through a narrow alley and travels to a destination or a second travel path 302 on which a robot passes through a broad alley and travels to a destination between two kinds of alleys that a robot should pass through for travelling to a destination.

According to an embodiment, in case an external robot connected to the robot 100 is the first external robot 201, the processor 140 may receive the appearance characteristic information of the first external robot 201 through the interface 130, and store the information in the memory 110. The processor 140 may identify whether the robot 100 and the first external robot 201 can sequentially pass through a narrow alley existing in the travel space based on information about the horizontal length of the first external robot 201 among the appearance characteristic information of the first external robot 201 stored in the memory 110.

Specifically, the processor 140 may obtain information about the width of the narrow alley based on map data for the travel space stored in the memory 110, and compare the width of the narrow alley with each of the horizontal length of the robot 100 and the horizontal length of the first external robot 201. If it is determined that any one of the horizontal length of the robot 100 and the horizontal length of the first external robot 201 is bigger than the width of the narrow alley, as the robot and the first external robot 201 cannot sequentially pass through the narrow alley, the processor 140 may identify the first travel path 301 as a path that cannot be travelled. In contrast, if it is determined that both of the horizontal length of the robot 100 and the horizontal length of the first external robot 201 are smaller than the width of the narrow alley, as the robot and the first external robot 201 can sequentially pass through the narrow alley, the processor 140 may identify the first travel path 301 as a path that can be travelled. In case the horizontal length of an object loaded on the first external robot 201 is bigger than the horizontal length of the first external robot 201, the processor 140 may identify whether the travel path can be travelled based on the horizontal length of the object.

Accordingly, in case the external robot connected to the robot 100 is the first external robot 201 of which horizontal length is smaller than the width of the narrow alley, the processor 140 may set the first travel path 301 as the travel path. Also, as the horizontal length of the second external robot 202 is bigger than the width of the narrow alley and smaller than the width of the broad alley, in case the second external robot 202 is connected with the robot 100, the processor 140 may set the second travel path 302 as the travel path.

In the aforementioned explanation, only a method of setting a travel path based on information about the horizontal lengths of the robot 100 and the external robot 200, and the widths of the alleys was explained, but this is merely an example, and it may be identified whether a travel path can be passed through based on various characteristics of the robot 100 such as comparing the height information of the robot 100 and the external robot 200 with the height of the travel space, etc.

In the aforementioned explanation, it was described that information about the width of a narrow alley existing in a travel space can be obtained based on the map data stored in the memory 110, but this is merely an example, and it is obvious that distance information about a travel space can be obtained based on sensing data obtained through various sensors that can detect distances such as a LiDAR sensor, a ToF sensor, a camera, etc. provided on the robot 100.

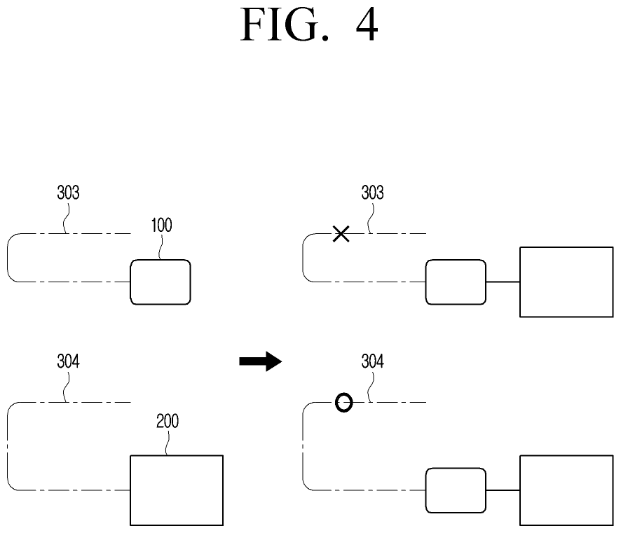

FIG. 4 is a diagram for illustrating a method of setting a travel path of a robot according to at least one embodiment of the disclosure.

According to FIG. 4, the processor 140 may set a travel path based on a turning radius of the external robot 200 connected with the robot 100.

A turning radius indicates, based on a center of rotation of a curved route in case the robot 100 or the external robot 200 travels on a curved route, by how much distance the robot 100 or the external robot 200 is distanced from the center of rotation. For conservation of angular momentum, a turning radius cannot help getting bigger as the size of the rotating robot gets bigger.

For example, as illustrated in FIG. 4, as the size of the robot 100 is smaller than the size of the external robot 200, while the robot 100 can travel on a third travel path 303 having a small turning radius, the external robot 200 cannot help travelling on a fourth travel path 304 having a bigger turning radius than that.

According to an embodiment, if the robot 100 is connected with the external robot 200, the processor 140 may obtain travel characteristic information including the turning radius of the external robot 200 through the interface 130, and store the information in the memory 110, and compare the turning radius of the robot 100 and the turning radius of the external robot 200 stored in the memory 110 and identify a bigger value, and then set only a curved path having a turning radius greater than or equal to the identified value as the travel path. Specifically, if the turning radius of the external robot 200 is 3 m while the turning radius of the robot 100 is 1 m, in case a curved path should be included in the travel path, the processor 140 may set such that the curved path has a turning radius greater than or equal to 3 m.

As illustrated in FIG. 4, in case the robot 100 and the external robot 200 are connected, the processor 140 may set the fourth travel path 304 having a bigger turning radius than the third travel path 303 as the travel path based on the turning radius of the external robot 200.

In the aforementioned explanation, a method for the processor 140 to set a travel path based on information about turning radiuses among the travel characteristic information was suggested as an example, but this is merely an example, and it is obvious that the processor 140 can set a travel path based on various travel characteristic information such as the maximum travel speed, the driving method, etc.

For example, in case the robot 100 is connected with the external robot 200, the processor 140 may obtain information about the maximum travel speed of the external robot 200 through the interface 130, and store the information in the memory 110. Then, the processor 140 may compare the maximum travel speed of the robot 100 and the maximum travel speed of the external robot 200 stored in the memory 110 and identify a smaller value, and identify the travel speed of the robot 100 and the external robot 200 as the identified smaller value.

Here, “the maximum travel speed” may mean the speed at which the robot 100 can travel at the maximum. In other words, it may mean the travel speed of the robot 100 determined based on an output of the driver 120 provided on the robot 100, the weight of the robot 100, etc.

According to an embodiment, if the maximum travel speed of the external robot 200 is 2 m/s while the maximum travel speed of the robot 100 is 4 m/s, the processor 140 may identify the travel speed of the robot 100 and the external robot 200 as 2 m/s, and control the driver 120 such that the robot 100 and the external robot 200 can travel at the identified travel speed.

According to another embodiment, the processor 140 may set a path that can be travelled within the target time among a plurality of paths through which a robot can travel to a destination as a travel path based on the identified travel speed. For example, if objects loaded on the robot 100 and the external robot 200 should be transported to a destination within 30 seconds, the target time may be 30 seconds. Here, if it is assumed that there are three paths in total through which a robot can travel to the destination, and each path includes travel distance as much as 60 m, 90, and 120 m, in order that a robot can travel on each path within 30 seconds, the robot should travel at the travel speed of 2 m/s, 3 m/s, and 4 m/s, respectively. If the travel speed identified by the processor 140 is 2 m/s as described above, only the path including the travel distance of 60 m among the three paths in total can be a path that can be travelled at the identified travel speed within the target time. Accordingly, the processor 140 may set the path including the travel distance of 60 m among the plurality of paths as the travel path, and control the driver 120 such that the robot 100 and the external robot 200 can travel on the set travel path.

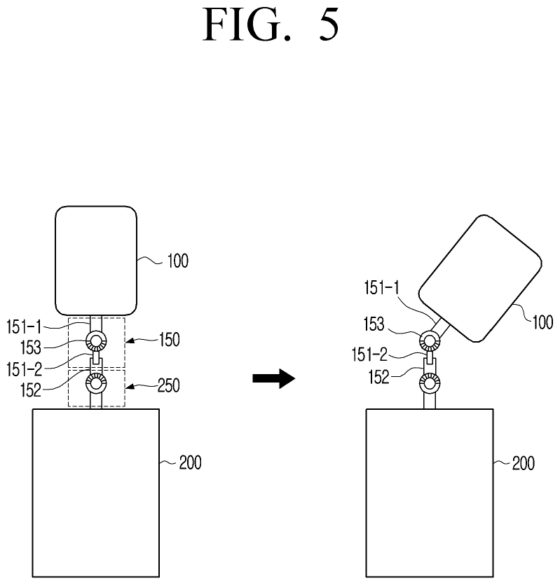

In the aforementioned explanation, a method of setting a travel path based on the characteristic information of the robot 100 and the external robot 200 was described in detail. Accordingly, in the explanation regarding FIG. 5 to FIG. 7 that will be described below, a method of connecting the robot 100 and the external robot 200 will be described in detail.

FIG. 5 is a diagram for illustrating a method of physically connecting a robot according to at least one embodiment of the disclosure.

FIG. 5 illustrates a connection structure between a connector 150 of the robot 100 and a connector 250 of the external robot 200.

The connector 150 is a structure that forms physical connection between the robot 100 and the external robot 200, and may be formed to protrude on the rear surface part or the side surface part of the robot 100. The connector 150 may include a plurality of connection elements 151-1, 151-2, a linear motion detection sensor 152, and a rotational motion detection sensor 153.

As the connector 250 provided on the external robot 200 can also be formed in an identical or a similar structure to this, only the connector 150 will be explained below.

The plurality of connection elements 151-1, 151-2 may be rotatably connected with each other. For example, between the first connection element 151-1 and the second connection element 151-2 and the rotation axis, a bearing or other lubrication elements, etc. for reducing a frictional force may be provided. Specifically, the first connection element 151-1 may include an accommodating part implemented as an empty space in a cylindrical shape, and the second connection element 151-2 may include a protruding part in a cylindrical shape that can be accommodated in the accommodating part provided on the first connection element 151-1. As the protruding part of the second connection element 151-2 is accommodated in the accommodating part of the first connection element 151-1, and a bearing, etc. are arranged on the accommodated protruding part, the first connection element 151-1 and the second connection element 151-2 may be rotatably coupled with each other with the center of the cylinder as the rotation axis.

Also, the second connection element 151-2 may be connected with the connector 250 of the external robot 200 such that a linear motion is possible. For example, the second connection element 151-2 may be connected in a form of a straight line between the connector 250 of the external robot 200, and while the robot 100 and the external robot 200 are travelling together through this, gravitational pull of the robot 100 may be transmitted to the external robot 200 as it is. An elastomer may be provided inside the second connection element 151-2, and in the connection part between the second connection element 151-2 and the connector 250 of the external robot 200, a joint element such as an elastomer that enables a linear motion, etc. may be provided.

According to an embodiment, the second connection element 151-2 may include a body in a cylindrical shape, and the connector 250 of the external robot 200 may include an accommodating part that can accommodate the body in a cylindrical shape. The body of the second connection element 151-2 may be coupled in a form of being accommodated in the accommodating part of the connector 250 of the external robot 200. In this case, an elastomer may be arranged within the accommodating part. By the elastomer, the second connection element 151-2 and the connector 250 of the external robot 200 can perform a linear motion such as being far from each other and then being close to each other within the range of the maximum modifiable distance.

In the aforementioned explanation, it was suggested as an example that the plurality of connectors 150, 250 include a protruding part in a cylindrical shape, or include a body in a cylindrical shape and can be coupled with each other, but this is merely an example, and the plurality of connection elements 151 may be implemented in various forms that can be coupled, without being limited to the aforementioned example.

Also, in the aforementioned explanation, it was suggested as an example that coupling between the plurality of connectors 150, 250 is formed by a bearing or an elastomer, but this is merely an example, and it is obvious that the plurality of connection elements 151 can be coupled by various joint elements, without being limited to the aforementioned example.

The linear motion detection sensor 152 is a sensor for detecting a linear motion between the second connection element 151-2 and the connector 250 of the external robot 200 that are connected such that a linear motion is possible. The linear motion detection sensor 152 may be implemented as various sensors such as an acceleration sensor, a stress sensor, etc. According to an embodiment, in case the linear motion detection sensor 152 is implemented as an acceleration sensor, the processor 140 may measure a change of the acceleration of the second connection element 151-2 based on sensing data of the linear motion detection sensor 152, and calculate a changed amount of the connection distance between the second connection element 151-2 and the connector 250 of the external robot 200 based on the changed amount of the acceleration of the second connection element 151-2. According to another embodiment, in case the linear motion detection sensor 152 is implemented as a stress sensor, the processor 140 may measure stress applied to the elastomer based on the sensing data of the linear motion detection sensor 152, and calculate a changed amount of the connection distance between the second connection element 151-2 and the connector 250 of the external robot 200 based on the measured stress value.

In the aforementioned explanation, it was explained that the linear motion detection sensor 152 may be implemented as an acceleration sensor or a stress sensor, but this is merely an example, and the linear motion detection sensor 152 may be implemented as various sensors that can detect distance such as a hall sensor, an infrared sensor, etc. without being limited to the aforementioned example. Also, in FIG. 5, it is illustrated that only one linear motion detection sensor 152 is provided in the connector 150, but according to the number of the connection elements that are coupled such that a linear motion is possible, a plurality of linear motion detection sensors 152 may be provided in the connector 150.

The rotational motion detection sensor 153 is a sensor for detecting a rotational motion between the plurality of connection elements 151-1, 151-2 that are connected such that a rotational motion is possible. In the connector 150, at least one rotational motion detection sensor 153 may be provided, and the rotational motion detection sensor 153 may be implemented as an encoder. In case the rotational motion detection sensor 153 is implemented as an encoder, the processor 140 may identify a connection angle between the connection elements based on sensing data of the rotational motion detection sensor 153. Specifically, the rotational motion detection sensor 153 may output data regarding how much a rotating disk rotated by scanning a location code that was binary-encoded on the rotating disk optically, and the processor 140 may identify in which direction a rotation between the connection elements was performed, and how much the rotation between the connection elements was performed based on the data output from the rotational motion detection sensor 153. Ultimately, the processor 140 may identify the connection angle between the connection elements constituting the connector 150.

In the aforementioned explanation, it was only suggested as an example that the rotational motion detection sensor 153 may be implemented as an encoder, but this is merely an example, and the rotational motion detection sensor 153 may be implemented as various sensors that can detect a rotational motion such as a hall sensor, an acceleration sensor, etc. without being limited to the aforementioned example. Also, in FIG. 5, it is illustrated that only two rotational motion detection sensors 153 are provided in the connector 150, but according to the number of the connection elements that are coupled such that a rotational motion is possible, rotational motion detection sensors in various numbers may be provided in the connector 150.

FIG. 5 only illustrates that two robots are connected by the connectors 150, 250, but this is only for the convenience of explanation, and it is obvious that n robots can be connected in order by n-1 connectors. For example, the connector 150 of the robot 100 may be directly connected to the accommodating part provided in the main body of the external robot 200.

Also, FIG. 5 illustrates only the connector 150 provided on the rear surface of the robot 100, but connectors 150 may be provided on the left and right side surfaces of the robot 100, and in such a case, it is obvious that one external robot can be connected to each of the left side, the right side, and the rear surface of the robot 100, and three external robots at the maximum can be connected to the robot 100.

In case the robot 100 is connected with the external robot 200 by the connector 150, the processor 140 may determine a virtual shape based on a connection state of the robot 100 and the external robot 200.

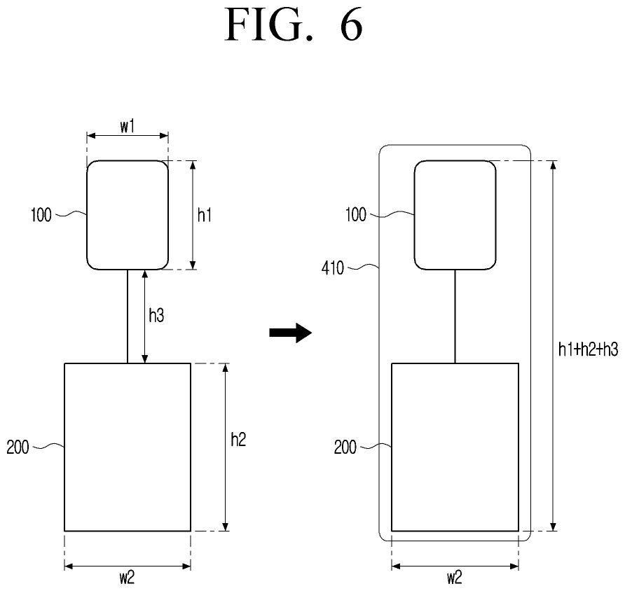

Here, “a virtual shape” may be the shape of a robot that the processor 140 arbitrarily determined for setting a travel path. In other words, in case a plurality of robots are connected with one another, considering the locations, the sizes, and the turning radiuses, etc. of each robot, the processor 140 may treat them as if a virtual robot having one big area on the whole is travelling. For example, a virtual shape may mean any shape that the processor 140 determines based on the appearance characteristic information of the robot 100 and the external robot 200, and the connection form of the robot 100 and the external robot 200, and a method for the processor 140 to determine a virtual shape will be described in detail in the explanation regarding FIG. 6 that will be described below.

FIG. 6 is a diagram for illustrating a method of determining a virtual shape of a robot according to at least one embodiment of the disclosure.

According to FIG. 6, the processor 140 may determine a virtual shape 410 based on the appearance characteristic information of the robot 100 and the external robot 200, and the form of the physical connection of the robot 100 and the external robot 200.

According to an embodiment, a case wherein both of the robot 100 and the external robot 200 are cuboid shapes, and the robot 100 and the external robot 200 are physically connected by the connector 150 as illustrated in FIG. 5 may be assumed. The processor 140 may identify the horizontal length w2 of the external robot 200 having a bigger value between the horizontal length of the robot 100 and the horizontal length of the external robot 200 as the horizontal length of the virtual shape 410. Also, the processor 140 may identify a value h1+h2+h3 that summed up all of the vertical length h1 of the robot 100, the vertical length h2 of the external robot 200, and the connection distance h3 by the connector 150 as the vertical length of the virtual shape. Ultimately, the processor 140 may determine a cuboid shape that has a horizontal length of w2, and a vertical length of h1+h2+h3 as the virtual shape.

As the processor 140 needs to set a travel path through which the robot 100 and the external robot 200 connected to the robot 100 can sequentially pass, the processor 140 may determine one virtual shape wherein the robot 100 and the external robot 200 are combined as described above. FIG. 6 illustrates a case wherein the connection angle between the robot 100 and the external robot 200 is 0 degree, but in case the connection angle is not 0 degree, the processor 140 may determine a virtual shape by also considering the connection angle between the robot 100 and the external robot 200.

According to an embodiment, returning to FIG. 5, the connection angle between the robot 100 and the external robot 200 may be changed to various values according to travelling of the robot 100. Accordingly, the processor 140 needs to identify a form of physical connection of the robot 100 and the external robot 200 that varies according to travelling of the robot 100, and determine a virtual shape based on the identified form of physical connection. For this, the processor 140 may identify a connection distance and a connection angle between the robot 100 and the external robot 200 based on sensing data of the linear motion detection sensor 152 and the rotational motion detection sensor 153, and correctly identify the form of physical connection of the robot 100 and the external robot 200 through this.

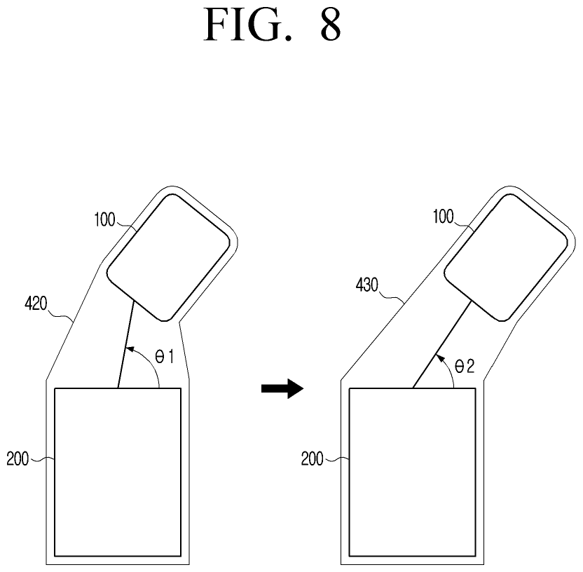

A method of determining a virtual shape based on an identified form of physical connection will be described in detail in the explanation regarding FIG. 8 that will be described below.

When the virtual shape 410 is determined by the aforementioned method, the processor 140 may set a travel path through which the virtual shape 410 can pass within the travel space based on the map data for the travel space stored in the memory 110, the travel characteristic information of the robot 100, and the travel characteristic information of the external robot 200.

Here, “a travel path through which the virtual shape 410 can pass” may mean a path wherein, if it is assumed that a travel device having the virtual shape 410 exists, the travel device can travel normally to a destination without colliding with a wall or an obstacle existing in the space. For example, the travel path may include a travel path that includes only an alley having a bigger width than the horizontal length of the virtual shape 410, and includes only a curved path having a bigger turning radius than the turning radius of the virtual shape 410.

The processor 140 may compare the turning radius of the robot 100 and the turning radius of the external robot 200 among the travel characteristic information, and identify a bigger value as the turning radius of the virtual shape 410. Also, the processor 140 may compare the maximum travel speed of the robot 100 and the maximum travel speed of the external robot 200 among the travel characteristic information, and identify a smaller value as the travel speed of the virtual shape 410. When the turning radius and the travel speed of the virtual shape 410 are identified, the processor 140 may set a travel path which is a travel path including only a curved path having a turning radius greater than or equal to the size of the identified turning radius, and through which the virtual shape 410 can travel to the destination within the target time (e.g., 30 seconds) based on the travel speed of the virtual shape 410.

In the aforementioned explanation, a method for the processor 140 to set a travel path through which the virtual shape 410 can pass based on the turning radius or the maximum travel speed among the travel characteristic information was suggested as an example, but the processor 140 may set a travel path through which the virtual shape 410 can pass based on various travel characteristic information without being limited to the aforementioned example, such as setting a travel path based on information about the driving methods of the robot 100 and the external robot 200 among the travel characteristic information, etc.

For example, in case the travel characteristic information includes information that both of the robot 100 and the external robot 200 include a differential module that can move in any direction without a rotation of the main body, the processor 140 may set a travel path such that only a straight path is included.

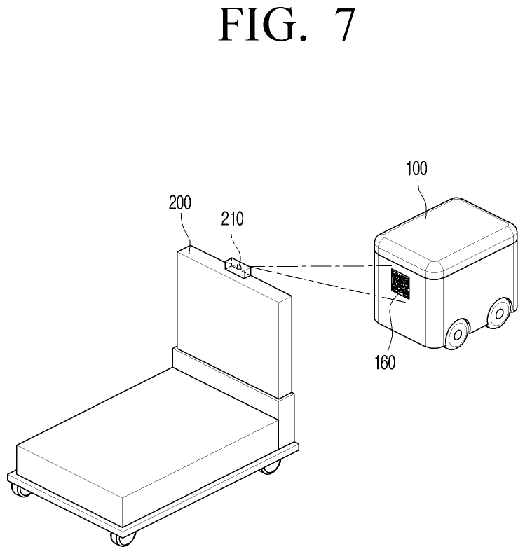

In the aforementioned explanation, it was explained that physical connection between the robot 100 and the external robot 200 can be formed through the connector 150, but connection between the robot 100 and the external robot 200 may be formed as the processor 140 provides a control signal to the external robot 200 that makes it located within a specific range from the robot 100, and detailed explanation in this regard will be described in the explanation regarding FIG. 7 that will be described below.

FIG. 7 is a diagram for illustrating a method of connecting a robot and an external robot according to at least one embodiment of the disclosure.

According to FIG. 7, the processor 140 may provide a control signal for moving to a location wherein the marker 160 provided on the exterior of the robot 100 can be sensed to the external robot 200 through the interface 130.

Here, the marker 160 is provided on the exterior of the robot 100, and may mean a mark that has a special pattern, a special shape, or a special color distinguished from the exterior of the robot 100. For example, the marker 160 may be implemented as “a fiducial marker” consisting of a black color and a white color, and may be implemented in a special color distinguished from the color of the exterior of the robot 100. Also, the marker 160 may be replaced by various terms such as a mark, a code, a pattern, a tag, etc.

In case a sensor 210 such as a camera or a LiDAR sensor, etc. is provided on the external robot 200, according to the location of the external robot 200 or the direction which the front surface part of the external robot 200 is toward, it is determined whether the sensor 210 provided on the external robot 200 can sense the marker 160. Accordingly, if the processor 140 keeps changing the location and the direction of the external robot 200 such that the sensor provided on the external robot 200 can sense the marker 160 provided on the rear surface of the robot 100, the external robot 200 can ultimately move to the same destination along the same path as the robot 100. For this, the processor 140 may transmit a control signal for moving to a location wherein the marker 160 can be sensed to the external robot 200 through the communication interface 130 or the input/output interface.

After the external robot 200 moves to a location wherein it can sense the marker 160 and senses the marker 160, the processor 140 may obtain sensing data that the sensor 210 of the external robot 200 sensed the marker 160 from the external robot 200 through the interface 130. Then, the processor 140 may identify the relative pose of the external robot 200 for the robot 100 based on the sensing data.

In case the sensor 210 of the external robot 200 includes a camera, the processor 140 may obtain an image that captured the marker 160 and a sensor parameter of the camera from the external robot 200. Here, the sensor parameter may mean a parameter that is needed for converting sensing data obtained through a sensor into data in a desired format, and the sensor parameter of the camera may include a principal point and a focal length of the camera, the location wherein the camera is attached on the external robot 200, etc.

In case the marker 160 is implemented as a radio frequency (RF) tag or a near field communication (NFC) tag, the sensor 210 may be implemented as an RF reader or an NFC reader.

The processor 140 may perform an operation based on the sensor parameter of the camera for the image that captured the marker 160, and identify the relative pose of the external robot 200 for the robot 100 through this. For example, the processor 140 may assume the coordinate of the center of the marker 160 as (0, 0, 0), and identify that the coordinate of the camera provided on the external robot 200 is (5, 5, 5) through an operation based on the sensor parameter. The processor 140 may figure out in which part of the exterior of the robot 100 the marker 160 is displayed, and figure out in which part of the external robot 200 the camera is provided based on the sensor parameter, and thus the processor 140 may ultimately identify the relative pose of the external robot 200 for the robot 100, and identify the direction which the front surface of the external robot 200 is toward.

In the aforementioned explanation, a case wherein the sensor 210 of the external robot 200 is a camera was suggested as an example, but this is merely an example, and it is obvious that the processor 140 can identify the relative pose based on sensing data of various sensors, like in a case wherein, if the sensor 210 of the external robot 200 is a LiDAR sensor, the processor 140 may identify the relative pose of the external robot 200 for the robot 100 based on sensing data of the LiDAR sensor and the sensor parameter.

When the relative pose of the external robot 200 is identified, the processor 140 may determine a virtual shape based on the identified relative pose and the information stored in the memory 110. For example, the processor 140 may identify how far the external robot 200 is distanced from the robot 100 based on the relative pose of the external robot 200, and identify the shapes and the sizes of the robot 100 and the external robot 200 based on the appearance characteristic information of the robot 100 and the external robot 200 stored in the memory 110. Accordingly, in case the robot 100 and the external robot 200 are not physically connected, the processor 140 may determine the virtual shape 410 as illustrated in FIG. 6 based on the aforementioned identification result. As the method of determining the virtual shape 410 was explained in detail in the explanation regarding FIG. 6, detailed explanation in this regard will be omitted.

FIG. 7 illustrates a scene wherein one external robot 200 is sensing the marker 160 provided on the rear surface of the robot 100, for the convenience of explanation, but the marker 160 may be provided on the side surface of the robot 100, and in case the robot 100 includes a plurality of markers 160, each of a plurality of external robots 200 may be controlled to respectively sense one marker 160, and the plurality of external robots 200 may be connected to the robot 100. Also, in FIG. 7, the marker 160 may be provided on the rear surface of the external robot 200, and another robot may be controlled to sense the marker 160 provided on the rear surface of the external robot 200, and two or more robots may be connected in order by such a method.

FIG. 8 is a diagram for illustrating a method of resetting a travel path of a robot according to at least one embodiment of the disclosure.

According to FIG. 8, the processor 140 may regenerate virtual shapes 420, 430 per predetermined period, and reset the travel path based on the regenerated virtual shapes 420, 430.

For example, in case the predetermined period is three seconds, the processor 140 may identify the connection form of the robot 100 and the external robot 200 every three seconds. Here, the feature of “identifying the connection form” may include identifying the connection distance and the connection angle between the robot 100 and the external robot 200, and may include identifying the relative pose of the external robot 200. By identifying the connection form of the robot 100 and the external robot 200 every three seconds, the processor 140 may determine the virtual shape corresponding to the connection state of the robot 100 and the external robot 200 every three seconds. In other words, the processor 140 may identify that the connection angle of the robot 100 and the external robot 200 was θ1 three seconds ago, but the connection angle is currently θ2. Also, the processor 140 may identify that the connection distance of the robot 100 and the external robot 200 was 1 m three seconds ago, but the connection distance is currently 1.5 m.

In the aforementioned explanation, a case wherein the processor 140 regenerates a virtual shape by identifying only a connection form of the robot 100 and the external robot 200 was suggested as an example, but this is merely an example, and it is obvious that the processor 140 can regenerate the virtual shape based on various characteristics such as the number, the shape, and the location, etc. of robots, like in a case wherein, if new robots are connected to the rear surface of the external robot 200, the processor 140 may reidentify the number of the connected robots per predetermined period and regenerate the virtual shape corresponding to the connection state of three or more robots.

The processor 140 may regenerate the virtual shape per predetermined period and identify whether the virtual shape can travel according to a travel path, and if it is determined that the virtual shape cannot travel, the processor 140 may reset the travel path based on the regenerated virtual shape and the information stored in the memory 110.

Here, the feature of “determining that the virtual shape cannot travel” may mean that the processor 140 determines that the regenerated virtual shape cannot pass through the travel path set previously. For example, in case the horizontal length of the regenerated virtual shape became longer than the previous virtual shape, and the virtual shape cannot pass through a narrow alley existing on the predetermined travel path, the processor 140 may determine that the virtual shape cannot travel.

The processor 140 may reset the travel path through which the regenerated virtual shape can pass based on the map data stored in the memory 110 and the characteristic information of the robot 100 and the external robot 200. As the method of setting a travel path through which the virtual shape can pass was explained in detail in the explanation part for FIG. 6, explanation in this regard will be omitted.

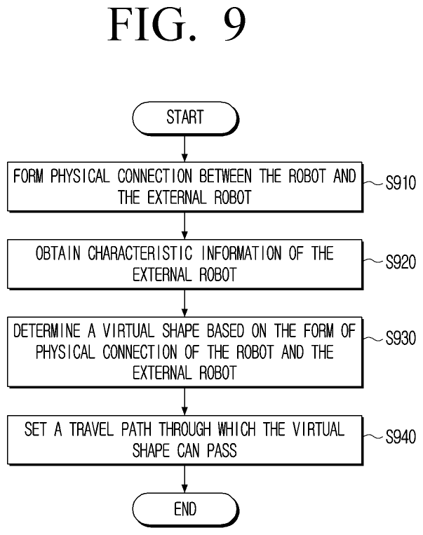

FIG. 9 is a diagram for illustrating a method of setting a travel path of a robot that is physically connected according to at least one embodiment of the disclosure.

According to FIG. 9, the robot may form physical connection with an external robot in the step S910. For example, the robot may form physical connection with an external robot through a connector provided on the rear surface of the robot. Here, the connector may consist of a plurality of connection elements, at least one linear motion detection sensor, and at least one rotational motion detection sensor.

Then, the robot may obtain characteristic information of the external robot in the step S920. Here, the characteristic information may include appearance characteristic information and travel characteristic information. Also, the appearance characteristic information may include information about the shape, the size, etc. of the robot, and the travel characteristic information may include information about the turning radius, the maximum travel speed, the driving method, etc. of the robot.

Then, the robot may determine a virtual shape based on the form of physical connection of the robot and the external robot in the step S930. Specifically, the robot may identify at least one of a connection angle or a connection distance between the robot and the external robot based on sensing values of at least one sensor included in the connector, and determine a virtual shape corresponding to the form of connection of the robot and the external robot based on at least one of the identified connection angle or connection distance.

Then, the robot may set a travel path through which the virtual shape can pass in the step S940. For example, the robot may set a travel path through which the determined virtual shape can move to a destination without colliding with a wall or an obstacle included in the travel space. Specifically, the robot may identify the turning radius of the virtual shape as a bigger value between the turning radius of the robot and the turning radius of the external robot, and identify the travel speed of the virtual shape as a smaller value between the maximum travel speed of the robot and the maximum travel speed of the external robot.

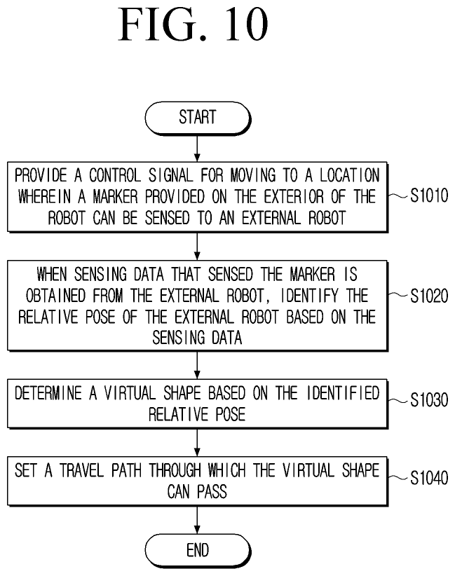

FIG. 10 is a diagram for illustrating a method of setting a travel path of a robot including a marker according to at least one embodiment of the disclosure.

According to FIG. 10, the robot may provide a control signal for moving to a location wherein a marker provided on the exterior of the robot can be sensed to an external robot in the step S1010.

Then, when sensing data that sensed the marker is obtained from the external robot, the robot may identify the relative pose of the external robot based on the sensing data in the step S1020. For example, in case a sensor of the external robot is a camera, the robot may obtain an image that captured the marker and a sensor parameter of the camera from the external robot, and identify the relative pose of the external robot based on the image that captured the marker and the sensor parameter of the camera. Specifically, the robot may calculate the relative pose of the external robot by performing an operation based on the sensor parameter of the camera for the image data that captured the marker.

Then, the robot may determine a virtual shape based on the identified relative pose of the external robot in the step S1030.

Then, the robot may set a travel path through which the determined virtual shape can pass in the step S1040.

The various kinds of methods explained in FIG. 9 and FIG. 10 may be performed by a robot having a configuration as illustrated in FIG. 2, but are not necessarily limited thereto, and they may be performed by robots having various configurations.

In the above, various embodiments were explained individually or in combination, but each embodiment is not necessarily implemented individually. In other words, the aforementioned various embodiments may be combined on the whole or partially with at least one other embodiment and implemented together in one product.

Meanwhile, methods according to the aforementioned various embodiments of the disclosure may be implemented in forms of applications that can be installed on a conventional robot.

Also, the methods according to the aforementioned various embodiments of the disclosure may be implemented just with software upgrade, or hardware upgrade for a conventional robot.

In addition, the aforementioned various embodiments of the disclosure may be performed through an embedded server provided on a robot, or through at least one external server.

Meanwhile, according to an embodiment of the disclosure, the aforementioned various embodiments may be implemented as software including instructions stored in machine-readable storage media, which can be read by machines (e.g.: computers). The machines refer to apparatuses that call instructions stored in a storage medium, and can operate according to the called instructions, and the apparatuses may include the electronic apparatus according to the embodiments disclosed herein. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, and does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or can be distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed:

1. A robot comprising:
a driver;
memory for storing at least one instruction, characteristic information of the robot, and map data for a space;
an interface; and
at least one processor,
wherein the at least one processor when executing the at least one instruction causes the robot to:
based on obtaining, through the interface, characteristic information of at least one external robot configured to travel by following the robot, store the characteristic information of the at least one external robot in the memory,
based on at least one of the characteristic information of the robot, the map data, and the characteristic information of the at least one external robot, set a path through which the robot and the at least one external robot can sequentially pass within the space, and
control the driver to travel based on the path.

2. The robot of claim 1,
wherein at least one of the characteristic information of the robot or the characteristic information of the at least one external robot comprises:
appearance characteristic information and travel characteristic information, and
wherein the at least one processor when executing the at least one instruction causes the robot to:
based on the at least one external robot being physically connected with the robot, determine a virtual shape based on the appearance characteristic information of the robot, the appearance characteristic information of the at least one external robot, and a form of physical connection of the robot and the at least one external robot, and
set the path through which the virtual shape can pass within the space based on the map data, the travel characteristic information of the robot, and the travel characteristic information of the at least one external robot.

3. The robot of claim 2, further comprising:
a connector configured to connect with the at least one external robot,
wherein the connector comprises:
at least one sensor, and
wherein the at least one processor when executing the at least one instruction causes the robot to:
based on a sensing value of the at least one sensor, identify at least one of a connection angle or connection distance between the robot and the at least one external robot, and
determine the virtual shape further based on at least one of the connection angle or the connection distance.

4. The robot of claim 1, further comprising:
a marker provided on the exterior of the robot,
wherein at least one of the characteristic information of the robot or the characteristic information of the at least one external robot comprises:
appearance characteristic information and travel characteristic information, and
wherein the at least one processor when executing the at least one instruction causes the robot to:
provide, through the interface, a control signal, for moving the at least one external robot to a location wherein the marker can be sensed, to the at least one external robot,
based on obtaining, from the at least one external robot, sensing data of the marker, identify a pose of the at least one external robot based on the sensing data,
determine a virtual shape based on the pose and at least one of the characteristic information of the robot, the map data, and the characteristic information of the at least one external robot, and
set the path through which the virtual shape can pass within the space based on the map data, the travel characteristic information of the robot, and the travel characteristic information of the at least one external robot.

5. The robot of claim 4,
wherein the at least one processor when executing the at least one instruction causes the robot to:
obtain, through the interface, an image of the marker captured by a camera, and a sensor parameter of the camera, and
identify the pose of the at least one external robot based on the image and the sensor parameter.

6. The robot of claim 2,
wherein the at least one processor when executing the at least one instruction causes the robot to:
in response to meeting a threshold period, regenerate the virtual shape and identify whether the virtual shape can travel along the path, and
based on determining that the virtual shape cannot travel along the path, reset the path based on the virtual shape and at least one of the at least one of the characteristic information of the robot, the map data, and the characteristic information of the at least one external robot.

7. The robot of claim 2,
wherein the travel characteristic information of the robot comprises:
a turning radius and a maximum travel speed of the robot, and
wherein the travel characteristic information of the at least one external robot comprises:
a turning radius and a maximum travel speed of the at least one external robot, and
wherein the at least one processor when executing the at least one instruction causes the robot to:
identify, as a turning radius value, a larger value between the turning radius of the robot and the turning radius of the at least one external robot, and set a turning radius of a curved path in the path to be greater than or equal to the turning radius value,
identify as a travel speed value, a smaller value between the maximum travel speed of the robot and the maximum travel speed of the at least one external robot, and
select, based on the travel speed value and a target time, a path that can be travelled at the travel speed value within the target time from among a plurality of paths.

8. The robot of claim 2,
wherein the travel characteristic information of the robot comprises:
a maximum travel speed of the robot, and
wherein the travel characteristic information of the at least one external robot comprises:
a maximum travel speed of the at least one external robot, and
wherein the at least one processor when executing the at least one instruction causes the robot to:
identify, as a travel speed value, a smaller value between the maximum travel speed of the robot and the maximum travel speed of the at least one external robot, and control the driver to travel at the travel speed value.

9. A travel method of a robot, the method comprising:
based on obtaining characteristic information of at least one external robot configured to travel by following the robot, setting a path through which the robot and the at least one external robot can sequentially pass within a space based on characteristic information of the robot and the characteristic information of the at least one external robot; and
controlling the robot to travel based on the path.

10. The travel method of a robot of claim 9, wherein at least one of the characteristic information of the robot or the characteristic information of the at least one external robot comprises:
appearance characteristic information and travel characteristic information, and
wherein the setting the path through which the robot and the at least one external robot can sequentially pass within the space comprises:
based on the at least one external robot being physically connected with the robot, determining a virtual shape based on the appearance characteristic information of the robot, the appearance characteristic information of the at least one external robot, and a form of physical connection of the robot and the at least one external robot; and
setting the path through which the virtual shape can pass within the space based on map data for the space, the travel characteristic information of the robot, and the travel characteristic information of the at least one external robot.

11. The travel method of a robot of claim 10,
wherein the determining the virtual shape comprises:
based on a sensing value of at least one sensor of a connector associated with the robot, identifying at least one of a connection angle or connection distance between the robot and the at least one external robot; and
determining the virtual shape further based on the appearance characteristic information of the robot, the appearance characteristic information of the at least one external robot, and at least one of the connection angle or the connection distance.

12. The travel method of a robot of claim 10, wherein at least one of the characteristic information of the robot or the characteristic information of the at least one external robot comprises:
appearance characteristic information and travel characteristic information, and
the method further comprising:
providing a control signal for moving, to a location where a marker provided on the exterior of the robot can be sensed, to the at least one external robot;
based on obtaining a sensing data of the marker from the at least one external robot, identifying a pose of the at least one external robot;
determining a virtual shape based on the pose, the appearance characteristic information of the robot, and the appearance characteristic information of the at least one external robot; and
setting a path through which the virtual shape can pass within the space based on the map data for the space, the travel characteristic information of the robot, and the travel characteristic information of the at least one external robot.

13. The travel method of a robot of claim 12,
wherein the identifying the pose of the at least one external robot comprises:
obtaining an image of the marker captured by a camera, and a sensor parameter of the camera; and
identifying the pose of the at least one external robot based on the image and the sensor parameter.

14. The travel method of a robot of claim 10, further comprising:
in response to meeting a threshold period, regenerating the virtual shape and identifying whether the virtual shape can travel along the path; and
based on determining that the virtual shape cannot travel along the path, resetting the path based on the virtual shape.

15. A non-transitory computer-readable recording medium storing computer instructions which, when executed by a processor of a robot, cause the robot to perform operations,
wherein the operations comprise:
based on obtaining characteristic information of at least one external robot that is to travel by following the robot, setting a path through which the robot and the at least one external robot can sequentially pass within a space based on characteristic information of the robot and the characteristic information of the at least one external robot; and
controlling the robot to travel based on the path.

16. The non-transitory computer-readable recording medium of claim 15, wherein at least one of the characteristic information of the robot or the characteristic information of the at least one external robot comprises:
appearance characteristic information and travel characteristic information, and
wherein the setting the path through which the robot and the at least one external robot can sequentially pass within the space comprises:
based on the at least one external robot being physically connected with the robot, determining a virtual shape based on the appearance characteristic information of the robot, the appearance characteristic information of the at least one external robot, and a form of physical connection of the robot and the at least one external robot; and
setting the path through which the virtual shape can pass within the space based on map data for the space, the travel characteristic information of the robot, and the travel characteristic information of the at least one external robot.

17. The non-transitory computer-readable recording medium of claim 16,
wherein the determining the virtual shape comprises:
based on a sensing value of at least one sensor of a connector associated with the robot, identifying at least one of a connection angle or connection distance between the robot and the at least one external robot; and
determining the virtual shape further based on the appearance characteristic information of the robot, the appearance characteristic information of the at least one external robot, and at least one of the connection angle or the connection distance.

18. The non-transitory computer-readable recording medium of claim 16, wherein at least one of the characteristic information of the robot or the characteristic information of the at least one external robot comprises:
appearance characteristic information and travel characteristic information, and
the method further comprising:
providing a control signal for moving, to a location where a marker provided on the exterior of the robot can be sensed, to the at least one external robot;
based on obtaining a sensing data of the marker from the at least one external robot, identifying a pose of the at least one external robot;
determining a virtual shape based on the pose, the appearance characteristic information of the robot, and the appearance characteristic information of the at least one external robot; and
setting a path through which the virtual shape can pass within the space based on the map data for the space, the travel characteristic information of the robot, and the travel characteristic information of the at least one external robot.

19. The non-transitory computer-readable recording medium of claim 18,
wherein the identifying the pose of the at least one external robot comprises:
obtaining an image of the marker captured by a camera, and a sensor parameter of the camera; and
identifying the pose of the at least one external robot based on the image and the sensor parameter.

20. The non-transitory computer-readable recording medium of claim 16, wherein the operations further comprise:
in response to meeting a threshold period, regenerating the virtual shape and identifying whether the virtual shape can travel along the path; and
based on determining that the virtual shape cannot travel along the path, resetting the path based on the virtual shape.
